(19) United States
(12) Patent Application Publication
(10) Pub. No.: US 2010/0307621 A1
(43) Pub. Date: Dec. 9, 2010

(54) HYDRAULIC VALVE DEVICE

(76) Inventor: Winfried Rüb, Waldshut-Tiengen (DE)

Correspondence Address: ROYLANCE, ABRAMS, BERDO & GOODMAN, L.L.P., 1300 19TH STREET, N.W., SUITE 600, WASHINGTON,, DC, 20036, US

(21) Appl. No.: 12/734,290

(22) PCT Filed: Sep. 17, 2008
(86) PCT No.: PCT/EP2008/007750

§ 371 Date: Apr. 22, 2010

(30) Foreign Application Priority Data
Nov. 14, 2007 (DE) 10 2007 054 134.3

(51) Int. Cl. F16K 15/00

(52) U.S. Cl. 137/861

(57) ABSTRACT

The invention relates to a hydraulic valve device, especially an LS current regulating valve, comprising a fluid connection arrangement (10) containing a plurality of useful connections and supply connections, and at least one mobile control device (14) for at least partially controlling the connections of the fluid connection arrangement (10). As the respective control device (14) associated with a useful connection (A,b) comprises a control slide (16) upstream of which a pressure balance (18) is mounted in the fluid direction towards each useful connection (A, B), any system vibrations occurring in the load sensing regulating circuit can be better controlled and the respectively connected hydraulic consumer can be subjected to a constant current regulation.

The invention relates to a hydraulic valve device, in particular a LS flow control valve, with a fluid connector arrangement containing at least the following:
a pressure supply connector (P),
a return flow connector (R),
a section load sensing connector (LS),
two control connectors (P′_{A}) and (P′_{B}),
two utility connectors (A, B) and
at least one displaceable control means for at least partially triggering connectors of the fluid connector arrangement.

DE 10 2005 033 222 A1 discloses a so-called LUDV valve arrangement in which a control valve forms an inlet metering orifice to which an individual pressure compensator is connected downstream. By means of the LUDV valve arrangement, a hydraulic consumer which is connected to two consumer connectors of the control arrangement is triggered. To set a quick traverse, two pressure spaces of the consumer can be connected to one another and to a source of hydraulic fluid. In order to prevent sagging of the consumer pressure, this connection of the two consumer connectors takes place by way of the flow path of the hydraulic fluid, in which there is a check valve. By way of the directional control valve, only the connection to one of the consumer connectors is opened; the connection of the other consumer connector to the source of hydraulic fluid and/or the former consumer connector is possible in quick traverse only via the flow path of the hydraulic fluid and the opened check valve. Inadvertent movement of a hydraulic consumer in the quick traverse position of the valve arrangement is prevented with the known solution. The known LUDV control constitutes a special case of load sensing control in which the highest load pressure of the hydraulic consumer is reported to an adjusting pump and the latter is controlled such that in the pump line there is a pump pressure which exceeds the load pressure by a certain pressure difference Δ_{P}. In the known LUDV control, the individual pressure compensators are located downstream from the metering orifices and choke the fluid flow between the metering orifice and the load so dramatically that the pressure following all metering orifices is the same, preferably equal to the highest load pressure or slightly above it. The greatest weakness of these hydraulic LS systems is their susceptibility to system vibrations in the load sensing control circuit, among other things due to the load change on the respective consumer.

EP 1 370 773 B1 discloses as a hydraulic valve device a directional control valve for controlling the pressure and the flow of hydraulic oil from and to working connectors of at least one fluid consumer, in which the pressure and flow rate can be controlled by means of a valve spool which can be moved in the spool bore and which can be actuated by at least one drive, and by means of annular channels dynamically connected thereto, at a so-called symmetry center point of the valve arrangement there being a tank connector annular channel (R) and on either side other annular channels being arranged symmetrically. Furthermore, for implementation of hydraulic pump triggering on one side of the indicated axis of symmetry, an A-annular channel which is assigned to one working connector, a first pump pressure annular channel, a first load sensing annular channel and a first end space annular channel are assigned, and on the other side of the axis of symmetry, a B-annular channel, which is assigned to the other working connector, a second pump pressure annular channel, a second load sensing annular channel, and a second end space annular channel are assigned. Furthermore, the first load sensing annular channel is connected to the second load sensing annular channel by way of a load sensing connecting line. With the known valve solution, a type of quantitative divider for the connected consumers is attained, in these quantitative divider valves the pressure compensators not controlling the pressure drop over the valve orifice, but accepting the highest load pressure of the system. Fluctuating pressure losses in the feed line then directly disrupt the available pressure difference on the controller orifice and, in this way, hinder constant flow control.

Proceeding from this prior art, the object of the invention is to further improve the known valve solutions such that system vibrations in the load sensing control circuit can be better managed and that constant flow control for the respectively connected hydraulic consumer is possible. This object is achieved by a hydraulic valve device with the features of claim 1 in its entirety.

In that, as specified in the characterizing part of claim 1, it is provided that the respective control means assigned to each utility connector A, B has a valve spool to which a pressure compensator is connected upstream in the fluid direction to the respective utility connector A, B, the hydraulic LS system is less susceptible to system vibrations. As a result of the upstream pressure compensator, it can have a decisive effect on system stability. Pressure oscillations are often produced by mechanical vibrations of resilient structures in the respectively connected hydraulic consumers (crane arms) and are then transmitted by the load sensing circuit (LS) to the pressure compensator. The LS pressure (load reporting pressure) then constitutes the reference variable for the upstream pressure compensator in this respect and can smooth pressure oscillations even before the pressure is relayed to the following valve spool of the respective control means which then, depending on its respective spool or piston position, ensures constant supply for the respectively connected hydraulic consumer.

In addition to the indicated system smoothing, it is ensured by the fluid succession from the pressure compensator with a downstream valve spool that, regardless of the pressure difference on the control means for the respective consumer, a constant useful volumetric flow is available so that the total flow rate remains constant independently of changing load pressures on the consumer and, accordingly, ensures reliable operation for the respectively connected hydraulic consumer.

In one preferred embodiment of the valve device according to the invention, the pressure compensator is integrated within the valve spool, both the pressure compensator and also the valve spool being guided to be longitudinally moveable in relative motion to one another within the valve housing. This coaxial arrangement of the valve spool and pressure compensator is especially space-saving and leads to valve housings with a small structure, this arrangement still being especially reliable.

Furthermore, it has also proven especially reliable if, in one preferred embodiment of the valve device according to the invention, both the pressure compensator and also the valve spool are held spring-centered in the initial position, the pressure compensator being triggerable by a LS pressure that is routed at the same time to one connection side of the valve spool which in turn can be triggered by the control pressure of a pilot valve, and, furthermore, a control connector pressure which is tapped between the valve spool and pressure compensator triggering the pressure compensator by acting in the opposite direction to the LS pressure.

Other advantageous embodiments of the valve device according to the invention are the subject matter of the other dependent claims.

The solution according to the invention is detailed below using one exemplary embodiment. The figures are schematic and not to scale.

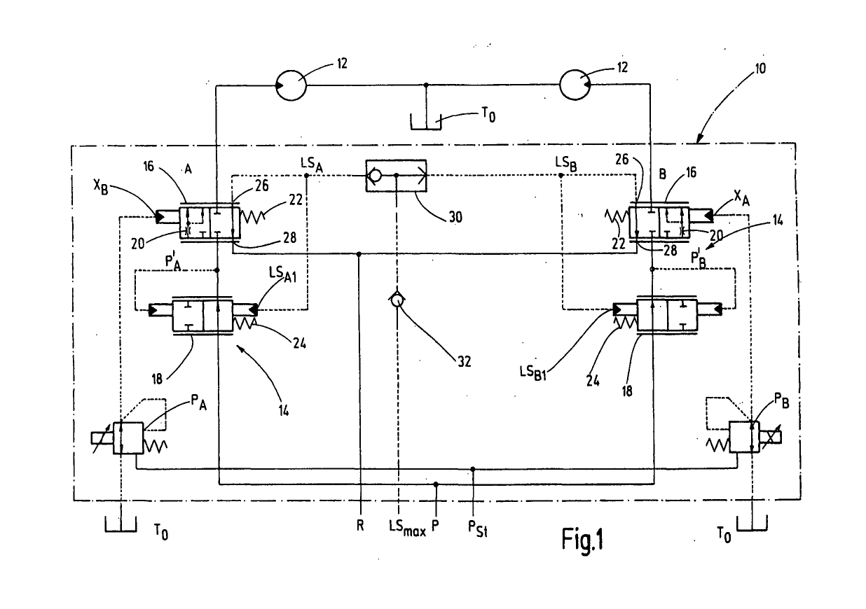

FIG. 1 shows, as a hydraulic circuit diagram, the fundamental structure of the hydraulic valve device in the form of a LS flow control valve;

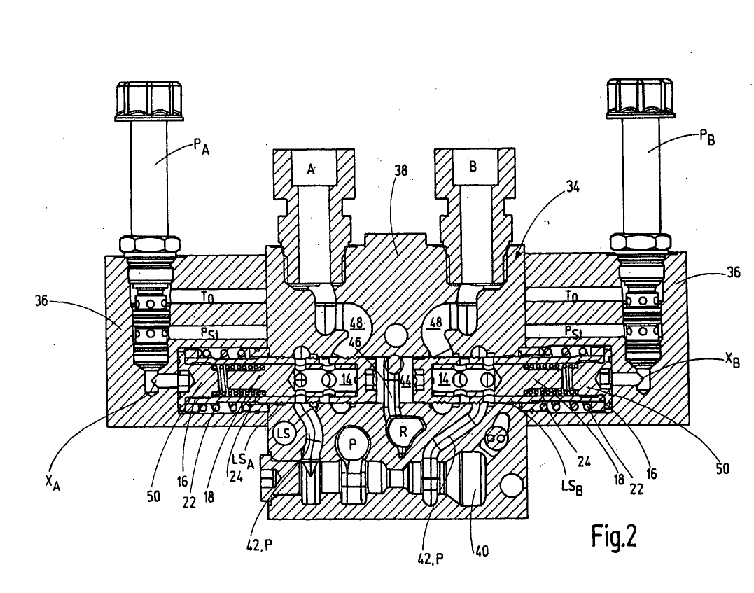

FIG. 2 shows the practical implementation of the circuit diagram as shown in FIG. 1 in a valve product which is shown in part with its essential components both in a longitudinal section and in a front view;

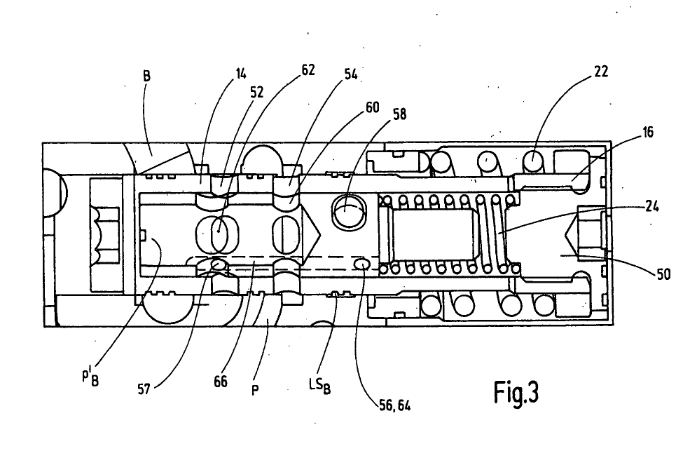

FIG. 3 shows an enlargement of a cutaway longitudinal view of the control means, which is at right when viewed in the direction of looking at FIG. 2, with a pressure compensator and valve spool.

The hydraulic valve device as shown in FIG. 1 has a fluid connector arrangement designated as a whole as 10, containing a pressure supply connector P, a return flow connector R, a section load sensing connector LS with LSₘₐₓ, two control connectors P′_{A}, P′_{B}, two utility connectors A, B, and two hydraulic motors 12 which are independent of one another and which are connected to the latter, as consumers which are connected to a common tank connector T₀. The hydraulic valve device furthermore has two control means designated as a whole as 14 for at least partial triggering of the connectors of the fluid connector arrangement 10. The respective control means 14 has, assigned to each utility connector A, B, a valve spool 16 to which a pressure compensator 18 is connected upstream. The valve spool 16 and pressure compensator 18 are built in the form of proportional valves, the respective valve spool 16 being provided with a type of throttle or orifice 20. Both the pressure compensator 18 and also the valve spool 16, as shown in FIG. 1, are held spring-centered in the initial position, the valve spool 16 for this purpose having one compression spring 22 and the pressure compensator 18 having another compression spring 24.

The respective pressure compensator 18 can be triggered by the LS pressure which is designated as LS_{A} and LS_{B} in FIG. 1. This LS pressure LS_{A}, LS_{B} is also routed at the same time to the connection side 26 of the valve spool 16. The respective valve spool 16 can furthermore be triggered against the action of the compression spring 22 by the control pressure X_{A}, X_{B} of a conventional pilot valve P_{A}, P_{B}, a control connector pressure P′_{A} and P′_{B} which has been tapped between the valve spool 16 and pressure compensator 18 triggering the pressure compensator 18 by acting in the opposite direction to the LS pressure LS_{A}, LS_{B}. The LS pressure prevailing directly at the input of the pressure compensator 18 here will be designated as LS_{A1} and LS_{B1}.

Another connection side 28 of the valve spool 16 is connected to a return flow connector R and the LS pressure LS_{A} and LS_{B} can be triggered by way of a selector valve 30 that is connected by way of a check valve 32 to LSₘₐₓ, the check valve 32 opening in the direction of LSₘₐₓ. The pilot valves P_{A}, P_{B} are connected to a control pressure P_{ST} as the supply source and further to the tank connector T₀.

The hydraulic valve device presented in FIG. 1 in the form of a hydraulic circuit diagram is now shown as a mechanical valve solution according to the longitudinal section as shown in FIG. 2. The valve device has a valve housing which is designated as a whole as 34, the valve housing being implemented as a modular concept. In particular, the pilot valves P_{A}, P_{B} with their connection housing parts 36 are connected to the middle housing 38, viewed in the direction of looking at FIG. 2 in the upper region of the middle housing 38, the utility connectors A, B being connected in the form of screw-in cartridges and in the lower region of the middle housing 38, its being penetrated by a through channel 40 in which overall the pump pressure P prevails, which is connected via connector lines 42 to a middle channel bore 44 into which the two control means 14 are inserted. Analogously to the through channel 40, the middle channel bore 44 also extends transversely to the center longitudinal axis of the overall valve housing 34 and along this center longitudinal axis which is not detailed, viewed in the direction of looking at FIG. 2, underneath the middle channel bore 44 is the return flow connector R which discharges into the middle channel 44 via another connector line 46. Furthermore, the middle channel 44 preferably made in the form of a bore is connected by way of connecting lines 48 to the utility connectors A, B to carry fluid. The check valve designated as 32 in FIG. 1 is likewise integrated in the valve housing 34; however, for reasons of simplification this is not detailed.

The axis of the respective valve spool 16, which axis runs horizontally when viewed in the direction of looking at FIG. 2, formed by the middle channel bore 44 in the middle housing 38, is in this respect sealed on both sides with the respective pilot housing as the connector housing part 36 for the supply of a trigger pressure X_{A}, X_{B}. Outside the valve middle is the return flow connector R and, viewed from the return flow connector R, on one side A, P, and LS_{A} follow to the outside, and B, P and LS_{B} on the opposite side. As already described, the LS annular channels LS_{A} and LS_{B} are connected to the selector valve 30 which separates the two pressures from one another. The selector valve 30 is preferably made as a round insert part and is mounted on the so-called flange side (not shown) of the disk-like valve body 34. The output connector of the selector valve 30 leads, by way of the pressure channel, to the check valve 32 which seals against higher pressure in the LS reporting channel (LSₘₐₓ). If the load pressure LS_{A} or LS_{B} exceeds the pressure in the reporting channel, this pressure is relayed by way of the check valve 32 in the control block and from there further to a system pressure control which is not detailed for the entire valve system.

The entire space in the form of the through channel 40 in the lower part of the middle housing 38 is under the pump pressure P and from this space one channel line at a time leads to the cavity axis of the respectively assignable valve spool 17 to the vicinity of the annular channels which lead to utility connectors A and B. The two valve spools 16 are made identically and in the coaxial arrangement hold an inside pressure compensator 18 which is connected upstream from the valve orifice and they are also structurally identical to one another. As shown in FIG. 2, in the neutral position the valve spools 16 are held in their position by housing-mounted stops and their respective working springs (compression springs 22). The working spring (compression spring 22) is supported on the one hand against the housing 34 of the valve and on the other hand against a screw plug 50 which is screwed tightly to the valve spool 16. In this initial or neutral position, the respective valve spool 16 separates the working connector A or B from the pump connector P.

As FIG. 3 shows in particular, the variable valve orifice is made in the form of first radial openings 52 within the hollow spool arrangement, consisting of the valve spool 16 and pressure compensator 18, here, a sealing crosspiece P to A and P to B forming within the valve housing 34. The inner pressure compensator 18 is also permanently connected to the pump channel P by way of second radial openings 54 in the valve spool 16. The spring chamber with the other compression spring 24 of the pressure compensator 18 is permanently connected to the respectively assignable LS_{A} or LS_{B} annular channel by way of third radial openings 56 in the valve spool 16. In the neutral position, the third radial openings 56 of the valve spool 16 are additionally connected to the spring chamber with the compression spring 22 of the valve spool 16, to carry pressure. This takes place through the corresponding radial passages in the control piston of the pressure compensator 18 and, accordingly, the indicated spring chamber of the pressure compensator 18 is then relieved in the neutral position. The valve spool 16 can be provided with fourth radial openings 57 whose edge which lies toward the valve center is at the same axial length as the first openings (control edge 52). These fourth openings 57, in contrast to the first three openings, do not have corresponding passages in the control piston of the pressure compensator 18. The correct orientation of the corresponding openings with passages is ensured by a locking element 58 in the form of a catch ball which in this respect offers radial protection between the valve spool 16 and the control piston of the pressure compensator 18.

In the unpressurized state the control spring 24 presses the control piston of the pressure compensator 18 against the end of the blind hole of the valve spool 16. This pressure compensator piston is likewise made as a hollow piston and has a second radial passage 60 which closes the connection to the opening 54 as a so-called P-opening in the valve spool 16 in the stroke against the pressure compensator spring 24 (control edge of the pressure compensator 18). A first radial passage 62 is permanently connected to the valve orifice in the form of the first opening 52 in the valve spool 16. The spring chamber of the pressure compensator 18 is connected by the third radial opening 56 to the respectively assignable third passage 64 of the valve spool 16 and, moreover, to the longitudinal grooves 66 on the jacket surface of the control piston of the pressure compensator 18. These longitudinal grooves 66, of which only one is shown by the broken line in FIG. 3, extend in the direction of the R channel to the control edge of the control piston and, viewed on the periphery, lie between the radial openings and passages. The respective longitudinal groove 66 is permanently connected to the fourth radial opening 57 in the valve spool 16. This longitudinal groove connection constitutes the LS reporting connector from the working connector into the spring chamber with the compression spring 24 of the pressure compensator 18. Here, the connection site 57, as shown in FIG. 1, corresponds to the branch point LS_{B} and the opening 56 on one input control side of the pressure compensator 18 forms the reporting connector LS_{B1}, whereas the above designated LS pressure LS_{B} constitutes the sensing connector.

When the pump pressure prevails over the pump connector P, this pressure also acts in the P′_{A} or P′_{B} chamber of the pressure compensator 18 and presses the control piston against the spring until the corresponding control edge closes so that the P′_{A} and P′_{B} pressure is adjusted exactly to the amount of the control spring 24 of the pressure compensator 18. It goes without saying that the aforementioned radial openings and passages, as also shown in FIG. 3, can be arranged repeatedly along the outer peripheries of the valve spool 16 and control piston of the pressure compensator 18.

If, at this point, a pilot pressure is selected by way of the pilot valves P_{A} or P_{B}, the pilot valve preferably being an electrohydraulic pressure reducing valve, with central supply from a control oil circuit P_{St}, the valve spool 16 is pushed against the spring force of the compression spring 22 in the direction of the R channel (compare FIG. 2). The valve orifice then begins to open an opening cross section between the pressure compensator 18 and the respectively assignable working connector A or B. Accordingly the P′_{A} or P′_{B} pressure breaks through because volume is draining. The control spring 24 can then push the control piston in the direction of the opening control edge and oil continues to flow out of the pump connector P until upstream from the valve orifice a dynamic pressure is formed again which is in equilibrium of forces with the control spring and the reported load pressure. The load pressure is then reported from the fourth radial opening 57 of the valve spool 16 into the longitudinal groove 66 which can likewise extend repeatedly around the periphery of the control piston, and is routed from there through the third radial opening 64 in the control piston into the spring chamber with the other compression spring 24. With the solution according to the invention, a system-stable valve device is defined which performs a LS flow control function in a space-saving manner.

1. A hydraulic valve device, in particular a LS flow control valve, with a fluid connector arrangement (10) comprising at least the following:
a pressure supply connector (P),
a return flow connector (R),
a section load sensing connector (LS),
two control connectors (P′_{A}) and (P′_{B}),
two utility connectors (A, B), and
at least one displaceable control means (14) for at least partially triggering connectors of the connector arrangement (10),
characterized in that the respective control means (14) assigned to each utility connector (A, B) has a valve spool (16) to which a pressure compensator (18) is connected upstream in the fluid direction to the respective utility connector (A, B).

2. The valve device according to claim 1, characterized in that the pressure compensator (18) is integrated within the valve spool (16) and that both the pressure compensator (18) and also the valve spool (16) are guided to be longitudinally displaceable in relative motion to one another within the valve housing (34).

3. The valve device according to claim 1, characterized in that both the pressure compensator (18) and also the valve spool (16) are held spring-centered in the initial position, that the pressure compensator (18) can be triggered by a LS pressure (LS_{A}, LS_{B}) which is routed at the same time to one connection side (26) of the valve spool (16) which can be triggered by the control pressure (X_{A}, X_{B}) of a pilot valve (P_{A}, P_{B}), and that a control connector pressure (P′_{A}, P′_{B}) which is tapped between the valve spool (16) and pressure compensator (18) triggers the pressure compensator (16) by acting in the opposite direction to the LS pressure (LS_{A}, LS_{B}).

4. The valve device according to claim 3, characterized in that a further connection side (28) of the valve spool (16) is connected to the return flow connector (R) which is routed essentially along the middle axis in the valve housing (34) and which runs in the initial position of the control means (14) between the opposite pairs of valve spools (16) with the pressure compensator (18).

5. The valve device according to claim 1, characterized in that the respective LS pressure (LS_{A}, LS_{B}) for the pressure compensator (18) is routed to a selector valve (30) which routes the higher of the two LS pressures (LS_{A}, LS_{B}) to the check valve (32).

6. The valve device according to claim 1, characterized in that a utility connector (A, B) is connected to the valve spool (16) to carry fluid.

7. The valve device according to claim 1, characterized in that both the valve spool (16) and also the pressure compensator (18) have hollow pistons that are guided within one another and that are provided at least partially with radial fluid openings (52, 54, 56, 57) and fluid passages (60, 62, 64) and that some of these fluid openings and fluid passages form a sensing connector (LS_{A}, LS_{B}) and a reporting connector (LS_{A1}, LS_{B1}).

8. The valve device according to claim 7, characterized in that the sensing connector (LS_{A}, LS_{B}) and the reporting connector (LS_{A1}, LS_{B1}) are interconnected by means of a longitudinal groove (66).

9. The valve device according to claim 1, characterized in that the pressure compensator (18) is held by means of a locking element (58) relative to the assignable valve spool (16).

10. The valve device according to claim 1, characterized in that as part of the valve housing (34) there is a through channel (40) as a distributor which, connected to the pump connector (P), supplies the respective control means (14) with fluid.
